(19) United States
(12) Patent Application Publication
(10) Pub. No.: US 2015/0323695 A1
(43) Pub. Date: Nov. 12, 2015

(54) TRANSMITTING AND RECEIVING ANTENNA FOR A SEARCH ANTENNA POLARIZATION INSTRUMENT

(71) Applicant: AMPASS-EXPLORER Corp., Tortola (VG)

(72) Inventor: Siegried STAUBER, Zurich (CH)

(21) Appl. No.: 14/699,935

(22) Filed: Apr. 29, 2015

(30) Foreign Application Priority Data
May 12, 2014 (EP) 14 401 059.2

(51) Int. Cl. G01V 3/10

(52) U.S. Cl. CPC G01V 3/101

(57) ABSTRACT

A transmitting and receiving antenna for a search antenna polarization instrument, including pivotably mounted about a support pin a resonance body serving as an antenna and an insulating plate beneath the resonance body serving as an electrode or second antenna, the insulating plate including a metal layer on the side that faces away from the resonance body, and including a magnet plate arranged non-rotatably at a distance from the insulating plate, the magnet plate including a shield on the side facing away from the insulating plate. One end of the resonance body is held between the magnet plate and an additional antenna magnet arranged near the resonance body, and the other end of the resonance body is braced by a holding magnet and held under tension relative to the normal position. Through a corresponding sawtooth control system, this antenna behaves in the manner of a singing saw having improved sensitivity.

### CROSS-REFERENCE TO RELATED APPLICATION

The present application claims priority under 35 USC §119 to European Patent Application No. 14 401 059.2, filed May 12, 2014, the entire disclosure of which is incorporated herein by reference.

### TECHNICAL FIELD

The present invention relates to an antenna for a search antenna polarization instrument for a material detector unit comprising pivotably mounted about a support pin a metallic resonance body serving as a first electrode or first antenna and an insulating plate serving as a second electrode or second antenna, the insulating plate being arranged below the resonance body and comprising a metal layer on the side that faces away from the resonance body, and comprising a magnet plate arranged non-rotatably at a distance from the insulating plate, wherein the metal layer of the insulating plate and the metallic resonance body form a capacitor that is part of an oscillator circuit of the material detector unit, and wherein the resonance body, the insulating plate and the magnet plate extend completely parallel to one another in a normal position, the resonance body and the insulating plate are connected to each other centrally, and at least the resonance body has free resonance body ends.

### DESCRIPTION OF THE RELATED ART

DE 103 29 335 B4 discloses a search antenna polarization instrument for a material detector unit. The search antenna polarization instrument described therein includes an antenna such as described above. This antenna includes pivotably mounted about a support pin a metallic resonance body, which is preferably made of a ferromagnetic material, serving as a transmitting and receiving antenna. Below the resonance body is an insulating plate that includes a metal layer, preferably a Mu-Metal layer, on the side facing away from the resonance body. A magnet plate is arranged non-rotatably above the resonance body at a distance from the insulating plate and the resonance body. In this configuration, the resonance body acts as a first antenna or electrode and the metal layer of the insulating plate acts as a second antenna or electrode, wherein the metal layer of the insulating plate and the metallic resonance body form a capacitor that is part of an oscillator circuit of the material detector unit. The resonance body, the insulating plate and the magnet plate extend completely parallel to one another, wherein the resonance body and the insulating plate are connected together centrally and at least the resonance body has free resonance body ends.

The object of the present invention is to further improve this known antenna and to improve the reception thereof for the search antenna polarization instrument.

This object is accomplished according to the invention through the features described herein. Other advantageous embodiments can be found in the claims dependent thereon.

### SUMMARY

According to the invention, the magnet plate is arranged on the side of the insulating plate facing away from the resonance body and includes a shield on the side facing away from the insulating plate, wherein the metal layer of the insulating plate is arranged on the side of the insulating plate facing away from the resonance body. In addition, an antenna magnet is arranged near the support pin at a first resonance body end of the resonance body, the magnet holding the first resonance body end between the magnet plate and the antenna magnet in the normal position. Moreover, a holding magnet is arranged on the magnet plate away from the support pin on the side of the plate that carries the shield, the holding magnet impacting on the other, second resonance body end of the resonance body, bracing the second resonance body end and thereby moving the same from the normal position and holding the end in place relative to the normal position under tension. In the normal position, the resonance body and the insulating plate extend parallel to one another separated by a lateral distance. Outside of the normal position, the second resonance body end of the resonance body associated with the holding magnet no longer extends parallel to the insulating plate, but is tilted relative to the insulating plate.

Thus, one resonance body end of the resonance body is held between the magnet plate and the additional antenna magnet arranged near the resonance body, such that one end of the antenna is held fixed. Meanwhile, the other resonance body end of the resonance body is held under tension by the holding magnet as a free end. The free resonance body end is thus held at the insulating plate at all times and the antenna is under tension in the longitudinal direction.

By means of the capacitor and the soft magnet electrodes used in conjunction therewith, the specific width and length relationships of the material being sought can be detected so that the dimensions of the material can be determined. The device according to the invention makes it possible to determine the position of the material sought, even from a greater distance away. The parts of the search antenna polarization instrument set forth in claim 1 form a resonant oscillator circuit, wherein the resonance body constituting the antenna represents the inductance L of the oscillator circuit. Provided that the resonance body comprised by the antenna is made of a ferromagnetic material, the above-mentioned inductance L of the resonance body increases due to the magnetic permeability, which is a material constant. This allows the resonant oscillator circuit to have a small resonance tuning capacity. This makes it easier to eliminate interference frequencies and retain the resonance frequency.

DE 103 29 335 B4, which is the underlying prior art for the transmitting and receiving antenna according to the invention, describes a search antenna polarization instrument for a material detector unit having a generic transmitting and receiving antenna, wherein the known antenna is connected to an electric circuit for use of the resonance member as a transmitting or receiving antenna. This prior art discloses a base circuit 58, shown in FIG. 23, in the form of a series oscillator circuit for operating the antenna. The antenna according to the invention is a further improvement of the known antenna. In the improvement, the resonance body 2 can be connected to a first 50 to 300 pF capacitor 59, which can also be bridged with a second variable 0 to 50 pF capacitor 60. The output of both capacitors is connected to a first diode 61 and to a second diode 62. The first diode is connected at the other side thereof to an amplifier, which is not shown; the second diode is connected to a 200 kΩ resistor 63. The resistor 63 is also connected to a 9-volt DC power supply. The disclosed base circuit operates using 0 to 8 volt DC power. The diodes 61, 62 can be designed as impedance converters here. It is also possible to use DC or AC signal field effect transistors instead of the diodes mentioned above. The base circuit mentioned is suitable for AC and DC signals.

If, as in a special embodiment of the invention, the antenna is subdivided into a shorter and a longer section relative to the support pin, and if the antenna magnet is arranged in the shorter section and the holding magnet is arranged in the longer section, the antenna can be operated as a “singing saw”. To this end, the same signal is sent to the electrode (the second antenna) and the resonance body as the antenna and only the difference is evaluated using a corresponding electronic circuit. Thus, almost all ambient magnetic and electrical effects are canceled. Then, the antenna functions like a “singing saw” with a fixed resonance body end and a loose resonance body end under tension. Instead of mechanical saw teeth, a controlled electrical sawtooth signal (period=sawtooth+pause) is sent, and the return signal is evaluated in the pause as described in DE 103 29 335 B4.

In order to optimally tune the transmitting and receiving antenna and to maximize the sensitivity thereof, the holding magnet is made to be displaceable along the longer section in the longitudinal direction so that the magnet can be moved toward or away from the free resonance body end.

According to another preferred embodiment of the invention, so as to allow optimum holding force in a small space, the holding magnet, which is a neodymium magnet, is designed to have a magnetic flux density of up to 150 mT to 200 mT.

The transmitting and receiving antenna for the search antenna polarization instrument according to the invention, for the search antenna polarization instrument for a material detector unit described in DE 103 29 335 B4, is characterized by a higher sensitivity for the signals to be measured. The content of DE 103 29 335 B4 is incorporated into this application as necessary.

The invention is described in more detail below with the aid of an exemplary embodiment together with the accompanying drawings. Other features of the invention follow from the following description of an exemplary embodiment of the invention in connection with the claims and the drawings. The individual features can be realized in and of themselves or as multiple embodiments of the invention. Shown are:

### BRIEF DESCRIPTION OF THE DRAWINGS

FIG. 1 a section through an antenna for a search antenna polarization instrument along line A-A of FIG. 2; and

FIG. 2 a view from above of the antenna according to FIG. 1.

### DETAILED DESCRIPTION OF THE INVENTION

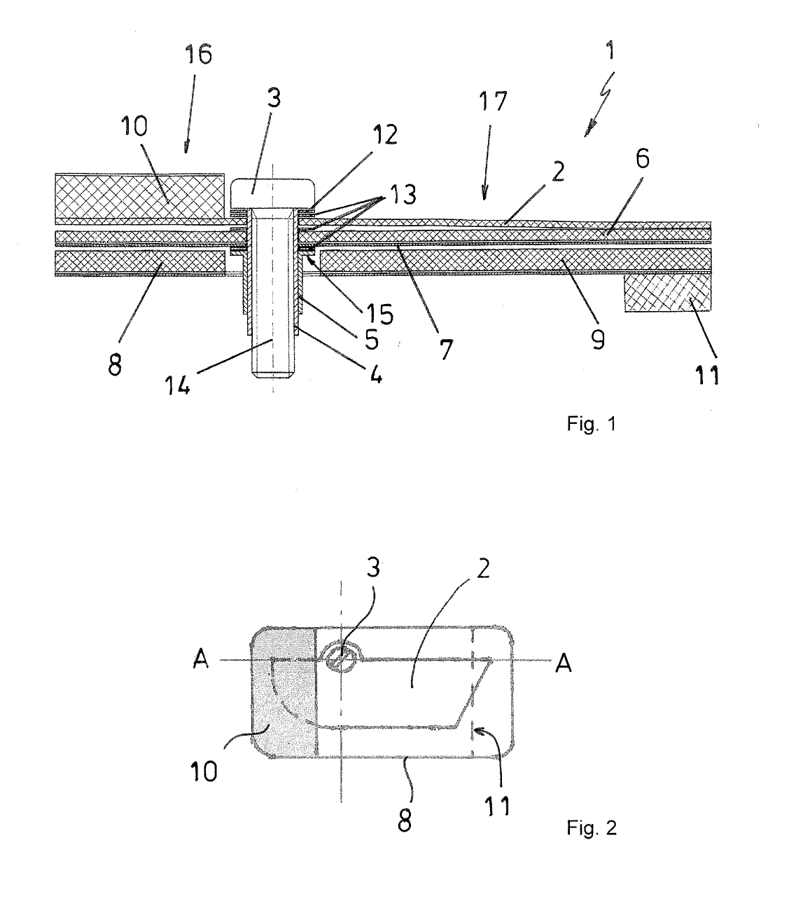

FIG. 1 shows the transmitting and receiving antenna 1 with the resonance body 2 that acts as an antenna, made of a thin nickel sheet held by a pin 3, pivotably about the longitudinal axis of the support pin 3, which is in the form of a Phillips head screw in a holder, which is not shown. The support pin 3 includes an insulating Teflon tube 4 along the shaft 14 thereof and surrounding the shaft. Above the pin is a rivet sleeve 5 that has a seating flange for supporting an insulating plate 6 which is placed a distance away from the resonance body 2. Spacer rings 13 are arranged both on the flange 15 and between the resonance body 2 and the insulating plate 6 and above the resonance body 2. The resonance member 2 and the insulating plate 6 are pivotably fixed between the top of the support pin 3 and the seating flange 15 of the rivet sleeve 5, by way of a corrugated washer 12 between the upper spacer ring and the top of the support pin 3. The insulating plate 6 can be made of polycarbonate or ceramic, for example. An electrode 7, which can also function as a second antenna, for example in the form of a copper film, is applied to the insulating plate. Below the insulating plate 6 and arranged non-rotatably at a distance therefrom, there is a magnet plate 8 that includes a shield 9 on the bottom thereof, the shield being likewise made of a copper film, for example. As can be seen from the figure, the support pin 3 is arranged such that the pin partitions the resonance body 2, the insulating plate 6 and the magnet plate 8 into a smaller section 16 and a larger section 17. This design has already been disclosed in principle in DE 103 29 335 B4.

The magnet of the magnet plate has a magnetic flux density of 15 to 20 mT, for example. On the shorter section 16 of the resonance body 2 there is an antenna magnet 10 with a strength of about 10 mT, for example in the form of a plastic magnet which, together with the opposing section of the magnet plate 8, holds the short resonance body end of the resonance body 2 fixed. At the free resonance body end of the longer section 17 of the antenna 1, there is a holding magnet 11 arranged at the magnet plate 8, for example a neodymium magnet, with a strength of up to 150 mT to 200 mT and a diameter of 3-6 mm, away from the support pin 3 on the side of the carrying shield 9. This holding magnet can be shifted along the magnet plate 8 and the longer section 17 of the antenna 1 in the longitudinal direction in order to optimize the sensitivity of the transmitting and receiving antenna to meet particular requirements. By using a small, strong holding magnet 11 of this type, the opposite area of the resonance body 2 is pressed against the insulating plate 6 (pulled against the plate), the plate preferably holding the free resonance body end fixed in the area of the holding magnet 11. Through appropriate controls using a sawtooth signal with a pause, the returning transmitted signal can be received in the pause and evaluated with improved sensitivity, as compared to the prior art, using a difference circuit for the signals, the circuit being arranged between the electrode 7 and the resonance body 2.

FIG. 2 shows the transmitting and receiving antenna from above such that the shape of the resonance body 2 and the insulating plate 6 arranged therebelow can be seen. The location of the support pin 3 relative to the resonance body 2 and the insulating plate 6 is also seen. This embodiment of the resonance body 2 is known from DE 103 29 335 B4. The magnet plate 8 below the resonance body 2 and the insulating plate 6 have larger dimensions, as can be seen in the figure. In this view, the antenna magnet 10 hides part of the shorter section of the resonance body 2 and the insulating plate 6, and the holding magnet 11, which is arranged below the magnet plate 8, is indicated by a dashed line. The sectional representation according to FIG. 1 shows a section along line A-A such that in connection with the representation in FIG. 1, it can be seen that only the tip of the resonance body 2 is held fixed at the insulating plate 6.

Although the device has been shown and described with respect to certain embodiments, it is obvious that equivalents and modifications will occur to others skilled in the art upon the reading and understanding of the specification. The device includes all such equivalents and modifications, and is limited only by the scope of the following claims.

1. A transmitting and receiving antenna for a search antenna polarization instrument for a material detector unit comprising pivotably mounted about a support pin, a metallic resonance body serving as a first electrode or first antenna and an insulating plate serving as a second electrode or second antenna, the insulating plate being arranged below the resonance body and comprising a metal layer on the side that faces away from the resonance body, and comprising a magnet plate arranged non-rotatably at a distance from the insulating plate, wherein the metal layer of the insulating plate and the metallic resonance body form a capacitor that is part of an oscillator circuit of the material detector unit, and wherein the resonance body, the insulating plate and the magnet plate extend completely parallel to one another in a normal position, the resonance body and the insulating plate are connected to each other centrally, and at least the resonance body has free resonance body ends, wherein:
the magnet plate is arranged on the side of the insulating plate that faces away from the resonance body, the magnet plate comprising a shield on the side facing away from the insulating plate,
an antenna magnet is arranged near the support pin at a first resonance body end of the resonance body, said antenna magnet fixing the first resonance body end between the magnet plate and the antenna magnet in the normal position, and
a holding magnet is arranged at the magnet plate away from the support pin on the side carrying the shield, the holding magnet impacting on the other second resonance body end of the resonance body in the normal position, bracing said second resonance body end and holding the same under tension relative to the normal position.

2. The transmitting and receiving antenna according to claim 1, wherein the support pin partitions the antenna into a shorter section and a longer section and the antenna magnet is arranged in the shorter section and the holding magnet is arranged in the longer section.

3. The antenna according to claim 2, wherein the holding magnet can be shifted along the longer section in the longitudinal direction.

4. The antenna according to claim 1, wherein the holding magnet is designed as a neodymium magnet with a magnetic flux density of up to 150 mT to 200 mT.
